(19) United States
(12) Patent Application Publication
(10) Pub. No.: US 2013/0109301 A1
(43) Pub. Date: May 2, 2013

(54) D2D Discovery Process

(71) Applicants: Sami-Jukka HAKOLA, Kempele (FI); Timo Koskela, Oulu (FI); Samuli Turtinen, Li (FI)

(72) Inventors: Sami-Jukka HAKOLA, Kempele (FI); Timo Koskela, Oulu (FI); Samuli Turtinen, Li (FI)

(73) Assignee: Renesas Mobile Corporation

(21) Appl. No.: 13/288,328

(22) Filed: Nov. 3, 2011

(30) Foreign Application Priority Data
Nov. 2, 2011 (GB) 1118928.9

(51) Int. Cl. H04W 88/02

(52) U.S. Cl. 455/39

(57) ABSTRACT

There is provided a method including obtaining, by a user terminal capable to perform direct device-to-device, D2D, communication with another user terminal, information indicating tracking area-specific resources for a D2D discovery process; and applying the obtained tracking area-specific resources in performing the D2D discovery process within the tracking area, wherein the D2D discovery process is for discovering D2D communication capable devices in the tracking area over an air interface of a cellular network.

### FIELD

The invention relates generally to mobile communication networks. More particularly, the invention relates to providing resources for a device-to-device (D2D) discovery process.

### BACKGROUND

In radio communication networks, such as the Long Term Evolution (LTE) or the LTE-Advanced (LTE-A) of the 3^{rd} Generation Partnership Project (3GPP), network planning comprises the use of common base stations (Node B, NB). User equipment (UE) may communicate with another UE via the base station(s), for example. Alternatively, it is proposed that the UEs may communicate directly by applying resources dedicated by the network for a device-to-device (D2D) communication. The D2D communication has proven to be network efficient by offloading the traffic processed in the base station(s), for example.

The D2D capable devices may trigger a so-called D2D discovery process in which the device may advertise its capabilities and/or search for other devices capable of D2D communication. However, known discovery processes apply resources, such as the Bluetooth or a near field communication (NFC) protocol, which may not be optimal for device discovery.

### BRIEF DESCRIPTION OF THE INVENTION

Embodiments of the invention seek to improve the D2D discovery process.

According to an aspect of the invention, there are provided methods as specified in claims 1 and 6.

According to an aspect of the invention, there are provided apparatuses as specified in claims 7 and 15.

According to an aspect of the invention, there is provided a computer program product as specified in claim 20.

According to an aspect of the invention, there is provided an apparatus comprising means configured to cause the apparatus to perform any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a cellular communication network to which the present embodiments are applicable;

FIG. 2 shows a method for performing a D2D discovery process, according to an embodiment;

FIG. 3 shows example resources of the D2D discovery process, according to an embodiment;

FIG. 4 illustrates a configuration for three tracking areas;

FIG. 5 presents a signaling flow diagram for providing resources for the D2D discovery process, according to an embodiment;

FIG. 6 depicts an embodiment for providing resources for the D2D discovery process;

FIG. 7 illustrates a signaling flow diagram for providing resources for the D2D discovery process, according to an embodiment;

FIG. 8 shows a scenario where user terminal locates in a tracking area border, according to some embodiments; and

FIGS. 9 and 10 illustrate apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Radio communication networks, such as the Long Term Evolution (LTE) or the LTE-Advanced (LTE-A) of the 3^{rd} Generation Partnership Project (3GPP), are typically composed of at least one base station (also called a base transceiver station, a radio network controller. a Node B, or an evolved Node B, for example), at least one user equipment (UE) (also called a user terminal, terminal device or a mobile station, for example) and optional network elements that provide the interconnection towards the core network. The base station may be node B (NB) as in the LTE, evolved node B (eNB) as in the LTE-A, a radio network controller (RNC) as in the UMTS, a base station controller (BSC) as in the GSM/GERAN, or any other apparatus capable of controlling radio communication and managing radio resources within a cell. The base station may connect the UEs via the so-called radio interface to the network. In general, a base station may be configured to provide communication services according to at least one of the following radio access technologies (RATs): Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), LTE, and/or LTE-A. The present embodiments are not, however, limited to these protocols.

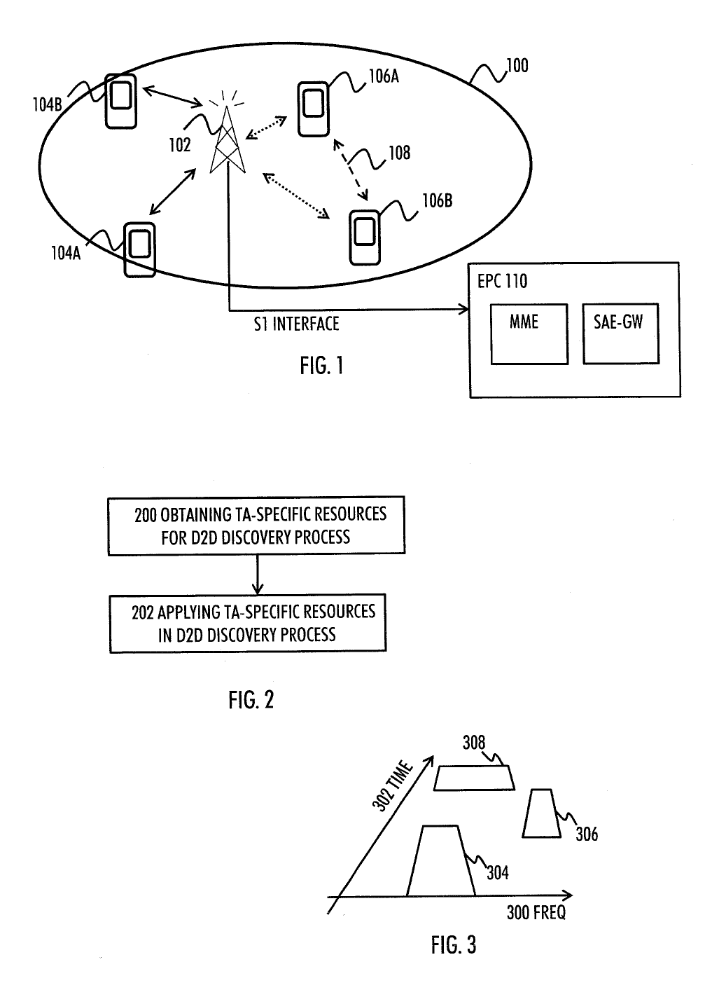

FIG. 1 shows a communication network where embodiments of the invention may be applicable. As explained, the communication network may comprise a base station 102. The base station 102 may provide radio coverage to a cell 100, control radio resource allocation, perform data and control signaling, etc. The cell 100 may be a macrocell, a microcell, or any other type of cell where radio coverage is present. Further, the cell 100 may be of any size or form, depending on the antenna system utilized.

The base station 102 may be used in order to provide radio coverage to the cell 100. For the sake of simplicity of the description, let us assume that the base station is an eNB. In the case of multiple eNBs in the communication network, the eNBs may be connected to each other with an X2 interface as specified in the LTE. The eNB 102 may be further connected via an S1 interface to an evolved packet core (EPC) 110, more specifically to a mobility management entity (MME) and to a system architecture evolution gateway (SAE-GW). The MME is a control plane for controlling functions of non-access stratum signaling, roaming, authentication, tracking area list management, etc., whereas the SAE-GW handles user plane functions including packet routing and forwarding, evolved-UMTS terrestrial radio access network (E-UTRAN) or LTE idle mode packet buffering, etc. The MMEs and the SAE-GWs may be pooled so that a set of MMEs and SAE-GWs may be assigned to serve a set of eNBs. This means that an eNB may be connected to multiple MMEs and SAE-GWs, although each user terminal is served by one MME and/or S-GW at a time.

Still referring to FIG. 1, the eNB 102 may control a cellular radio communication link established between the eNB 102 and terminal devices 104A and 104B located within the cell 100. These communication links marked with solid arrows may be referred as conventional communication links for end-to-end communication, where the source device transmits data to the destination device via the base station 100. Therefore, the user terminals 104A and 104B may communicate with each other via the base station 102. The terminal device may be a terminal device of a cellular communication system, e.g. a computer (PC), a laptop, a palm computer, a mobile phone, or any other user terminal or user equipment capable of communicating with the cellular communication network.

In addition to or instead of conventional communication links, direct device-to-device (D2D) connections may be established among terminal devices. Direct communication links between two devices may be established, e.g., between terminal devices 106A and 106B in FIG. 1. The D2D communication may take place between cognitive radio-based devices 106A and 106B, for example. A direct communication link 108 marked with a dashed arrow may be based on any radio technology such that the terminal devices 106A and 106B involved in the direct communication may apply communication according to any of a plurality of radio access technologies. The eNB 102 may be responsible for controlling the direct communication link 108, as shown with dashed, bi-directional line in FIG. 1. The radio access technology of the direct communication link 108 may operate on the same frequency band as the conventional communication link and/or outside those frequency bands to provide the arrangement with flexibility. Thus, the eNB 102 may be responsible for allocating radio resources to the direct communication link 108 as well as for the conventional communication links.

Terminal devices that have established a radio resource control (RRC) connection with the eNB 102 may have their D2D communication links 108 controlled by the eNB 102 as shown with dotted arrows in FIG. 1. The control of the D2D communication links 108 may be carried out when an associated terminal device is either in an RRC idle state or in an RRC connected state. In an RRC idle state, the terminal device has no active connection with the base station and no allocated radio resource but is capable of receiving RRC signalling information broadcasted by the eNB 102. Furthermore, the device in RRC idle state may perform UE based mobility and tracking area update procedure when triggered. In the RRC connected state, a radio resource controller of the eNB 102 has allocated radio resources to the terminal device for data transfer to the eNB. Additionally, the terminal device may be directly configured by the eNB 102 through RRC signalling. The RRC signalling may be used to configure the radio access technologies and communication parameters of the communication links, either direct communication links 108 or the conventional communication links.

Before such direct D2D communication may take place, the user terminals may need to be aware of the presence of other user terminals capable of D2D communication. In order to enable this, a D2D discovery process may be applied. In the discovery process, the user terminal (UT) capable of D2D communication applying the radio resources of the cellular communication network may, for example, inform other user terminals about the capability of performing D2D communication directly with another UT. The other UTs may listen to such signalling and in this way also perform the D2D discovery process functions. However, a cellular network may advantageously maintain control of the resources of the D2D discovery process. In other words, the cellular network, such as the LTE network, may employ such system architecture and security architecture that allow the 3GPP operators to retain control of the D2D device's behaviour. This behaviour may comprise, for example, information to determine who can emit the discovery signals, when and where, what information do the discovery signals carry, and what devices should do once they discover each other. The D2D discovery may also be supported in RRC idle state, in addition to the RRC connected state. In RRC idle there may be no RRC connection towards the eNB but the UT may have valid a IP address, it may have been authenticated and its security context may be stored in the MME. The RRC IDLE mode may provide an opportunity to have power efficient state for low duty cycle discovery and service advertisement signalling while being authenticated by the cellular network.

To provide an efficient and scalable solution for a radio-based discovery among D2D devices, the range of discovery signalling may advantageously be relatively long. This may mean that the discovery range may be over cells, i.e. not limited to one cell only. For this reason, it is proposed that the user terminal capable to perform direct device-to-device (D2D) communication with another user terminal may in step 200, as shown in FIG. 3, obtain information indicating tracking area-specific resources for a D2D discovery process. An UT capable to perform the D2D direct communication may be equipped with required functional entities relating to at least one of the following: cognitive radio, transceiver(s), radio resource management unit(s), detection units for discovering another UT with D2D capabilities, etc. It is to be noted that the obtained resources for the D2D discovery (D2D discovery resources) are specific to a certain tracking area (TA). This may denote that the resources are not necessarily specific within one cell only, but over a plurality of cells. Accordingly, in an embodiment, the tracking area comprises at least two cells. This may allow for tackling problems related to small coverage of discovery process and thus may enable the D2D devices to spot each other over cell borders in order to provide large coverage for discovery purposes.

The user terminal may then in step 202 apply the obtained tracking area-specific resources in performing the D2D discovery process within the tracking area, wherein the D2D discovery process is for discovering D2D communication capable devices in the tracking area over an air interface of a cellular network. In other words, the UT may perform the D2D discovery process on the resources so as to enable the UT(s) in the tracking area to discover the UT transmitting discovery signals on the resources. The other UTs listening to the D2D discovery process related signaling may know which resources to listen to from a common broadcast of D2D resources to all UTs in the tracking areas, for example. Such broadcast may be provided by any network entity in the cellular communication network, such as the eNB or the MME, for example. In an embodiment, the eNB may broadcast the information when, for example, the MME has configured the TA-specific resources and information related to the TA-specific resources, which are to be broadcasted.

The resources may, as shown in FIG. 3, comprise frequency 300, time 302 and transmission power, for example. In FIG. 3 it is shown that one UT may perform D2D discovery on resources 304 having a fixed time duration and starting time, center frequency, bandwidth and power, wherein the power is represented by the height of the resource block 304. At least partially different resources 306 and 308 may be given to other UTs so as to avoid two or more UTs performing D2D discovery process at the same resources within the TA to which the resources are specific for. The resources may be shared with the cellular communication system, such as the UMTS or the LTE-A, for example. The UT may apply the same radio access technology (RAT) as the cellular communication system. However, the UT may alternatively apply another RAT than the one applied by the cellular communication system. However, as the resources may be shared with the cellular network, it may be that the D2D resources are allocated such that they do not interfere with the conventional cellular communication links or with the control signaling of the network in the tracking area or in the cell. In this regard it should be noted that the proposed solution is substantially different from any D2D discovery process or communication using a particular radio access technology (RAT) in a predefined spectrum, such as Bluetooth in an ISM band. As the air interface of the cellular network is applied in the D2D discovery process, the UTs may be discovered over the air interface of the cellular communication system. The cellular network may be the serving cellular network of the UT or a network where the UT is roaming, for example.

The cellular network, such as the LTE network, may allow autonomous D2D discovery signal transmission on certain resources. It may be that the UTs are allocated, within the cell, a specific time slot and frequency when to transmit, wherein the time slot and the frequency are known to all or at least to some UTs in the cell. The known resources may be provided by the eNB or the MME, for example. The discovery process may comprise at least one user terminal transmitting a broadcast message on the known resources and for some other UTs to listening to the broadcast message. The broadcast message of the D2D discovery process may also comprise an identification of the transmitting UT, for example. In an embodiment, there may further be a predetermined time window for the D2D discovery process during which the UTs are allowed to transmit discovery signals in turns. The time window may comprise intervals when nobody is transmitting. Such silent periods may take place periodically during the plurality of time windows. Then, a receiver noticing such silent period may utilize the silent period by transmitting its own D2D discovery signal(s) in the next possible time window by applying the previously silent period, for example.

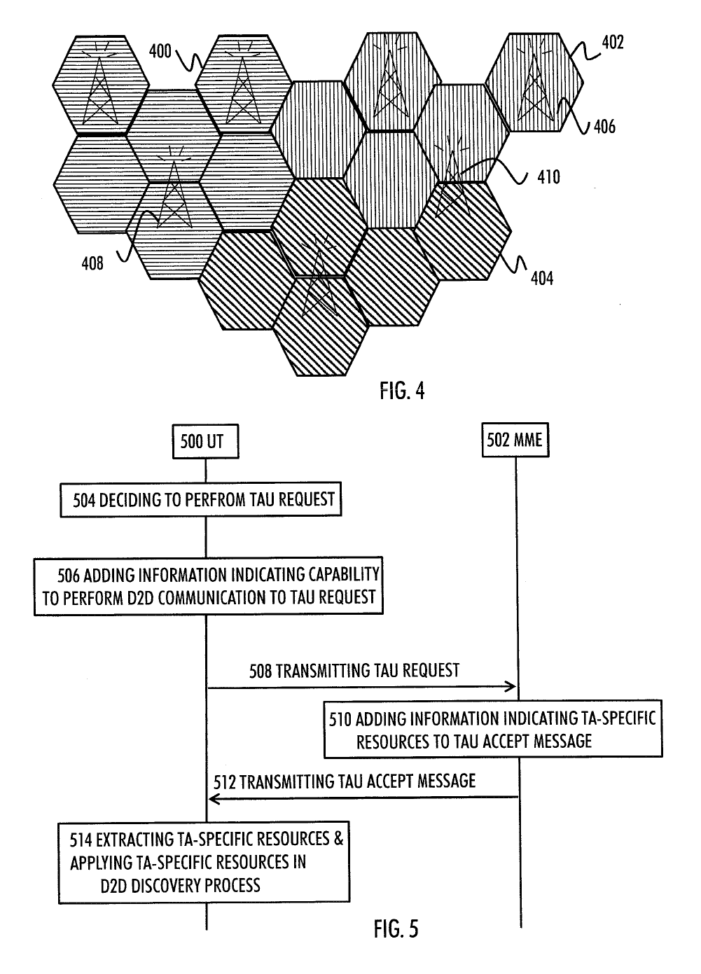

Let us take a look at the concept of tracking areas. FIG. 4 shows three tracking areas 400, 402 and 404 each comprising a plurality of cells each marked with a regular hexagon, although the form and size of the cell may vary. The tracking area 400 is marked with horizontal lines, the tracking area 402 is marked with vertical lines and the tracking area 404 is marked with left leaning diagonal lines. The tracking area may be seen as a common name for the area in which the mobile may be tracked. For example, in the GSM, mobiles may be tracked in location areas (LA) and in routeing areas (RA). In the UMTS, mobiles may be tracked in UTRAN registration areas (URA) as well as in LAs and in RAs. In the LTE, the definition of tracking area (TA) may be used as a generic name for LA, RA and URA. In the UTRAN, for example, the location may be known by a serving GPRS support node (SGSN) on a routing area granularity. In the LTE network, however, the location of a user terminal in the IDLE state may be known by a network element, such as by the MME, on a tracking area granularity. This way the MME may know the TA in which the UE last registered. This is helpful in paging procedures so as to locate the UT in some specific cell, for example.

Each eNB may contain cells belonging to different tracking areas, whereas each cell may only belong to one TA. Similarly one MME may take care of a plurality of TAs, whereas one TA is monitored by one MME only. As can be seen from FIG. 4, a base station 406 may provide radio coverage to a single cell whereas some base stations, such as a base station 408 may provide coverage to a plurality of cells. FIG. 4 also shows a base station 410 providing radio coverage to a plurality of cells, wherein the cells belong to different TAs 402 and 404.

Let us consider a start-up routine of a user terminal so as to illustrate the tracking area concept in cellular communication network. When a device is switched on, a public land mobile network (PLMN) is selected by Non-Access Stratum (NAS) protocol. The NAS is a functional layer in the wireless telecom protocol stack between core network and the user terminal. The NAS shall provide a list of equivalent PLMNs, if available, that the Access Stratum (AS) shall use for cell selection and cell reselection. With the cell selection, the device, such as the UT, searches for a suitable cell in the selected PLMN and chooses the suitable cell to provide available services. The UT may further tune to a control channel of the selected cell. The device may also register its presence, by means of a NAS registration procedure, in the tracking area of the chosen cell and as an outcome of a successful location registration, the selected PLMN becomes the registered PLMN. However, when the device finds a more suitable cell, according to the cell reselection criteria, it may reselect that cell and camp on it. If the new cell does not belong to at least one tracking area to which the device is registered so far, the location registration may again be performed. As the device, such as the UT, may be configured with a plurality of tracking areas, a so called tracking area list (TAL) may be provided. The TAL may be assigned in a scheme in which, instead of assigning one TA to a device, one device may have a list of plurality of TAs. The device may receive the TAL from the network via the base station. The UT may then keep the list until the UT moves to a cell that is not included in its any of the TA in the TAL.

When such scenario takes place where the UT moves to a TA not included in the TAL, a standalone tracking area update (TAU) request may occur in which the UT requests a new tracking area to be configured for the UT. The network may respond with a TAU accept-message in which a new TA may be configured to the UT. The new TA may comprise the cell where the UT is currently located. The TAU request may also take place when the UT (or UE) experiences any of the predetermined conditions given in 3GPP TS 23.401, “3rd Generation Partnership Project; Technical Specification Group Services and System Aspects; General Packet Radio Service (GPRS) enhancements for Evolved Universal Terrestrial Radio Access Network (E-UTRAN) access (Release 10)” v. 10.3.0, wherein the TAU procedure with and without S-GW change are presented, for example.

The user terminal may obtain such TA-specific resources in a plurality of ways, as will be clear from different embodiments. In addition, the information indicating the resources may come in many forms, thus the UT need not necessarily receive the exact resources but an index of the resources or an indication from where the resources may be obtained, etc. are sufficient as well. In an embodiment, the MME may provide the TA-specific resources to the UT via signaling or via alternative means, such as by applying a resource pool, as will be explained below.

In an embodiment, the UT may cause transmission of information to the cellular network, wherein the information comprises an indication of capability to perform direct D2D communication over the air interface of the cellular communication network. A network element, such as the MME, of the cellular communication network may then receive the information. The information may be at least one bit transmitted from the UT. The MME, as the example network element, may then cause transmission of information indicating the tracking area-specific resources to the UT. Thereafter, the UT may perform the D2D discovery process on the allocated TA-specific resources. The UT performing the discovery process may be discovered and acknowledged by UTs within the TA over a single cell borders. This may allow the first UT, who performed the D2D discovery process to perform direct D2D communication with a second UT which discovered the first UT. The second UT may be within the same cell as the first UT, for example. The direct communication may take place on same resources as the D2D discovery process, or the serving MME or the serving base station may allocate new resources which are to be applied in the D2D communication. The new resources may be cell-specific as the D2D communication may be limited to the one cell. Alternatively, the second UT may locate in a different cell as the first UT. In this case, the serving MME may allocate resources for the UTs to communicate directly with each other. In order for the two UTs to perform D2D communication, the UTs need to be sufficiently close to each other, although being in separate cells. Alternatively, the two serving base stations (one for the first UT and another for the second UT) may co-operate in allocating radio resources for the D2D communication so that the allocated resources do not substantially interfere with the other radio communication in the cells.

In still another embodiment, the first and second UTs who discovered each other in the D2D discovery process may perform conventional communication with each other.

In an embodiment the information indicating the capability to perform direct D2D communication is carried in a tracking area update request and the information indicating the tracking area-specific resources is carried in a tracking area update accept-message. FIG. 5 shows a user terminal (UT) 500 performing signaling with an MME 502 of the cellular communication network. The UT 500 may be pre-configured or enabled/activated later to perform D2D communication. By later activation/enabling it is meant that the cellular communication network may configure the UT 500 later with parameters and functionalities enabling the UT to perform D2D communication, as the UT 500 may be a cognitive radio device. The signaling between the entities may take place via the base station serving the UT 500, for example, although not shown in the figure. In step 504, the UT 500 may decide to perform a TAU request based on any of the predefined conditions as described above. However, instead of transmitting the ordinary TAU request, the UT 500 may in step 506, before transmitting the TAU request, add to the TAU request information indicating the capability to perform a direct D2D communication. Thereafter, the UT 502 may cause transmission of the TAU request carrying the indication to the MME in step 508. The indication may be at least one bit so that the receiver, such as the MME 502, may know that the UT 500 is capable to perform D2D communication. If the serving MME 502 is to accept the TAU request, the MME 502 may add information indicating the tracking area-specific resources in a tracking area update accept-message in step 510. The TAU accept-message may also comprise a new at least one TA configuration for the UT 500. The TA-specific resources may be specific for the newly allocated TA(s), for example. The UT 500 may also obtain TA-specific resources for a plurality of TAs if the UT is configured with a plurality of TAs because the MME may assign a list of TAs (TAL) to the UT 500. In step 512, the MME 502 transmits the TAU accept-message to the UT 500. After having received the TAU accept-message, the UT 500 may, in step 514, extract the TA-specific resources from the received message and apply the TA-specific resources in the D2D discovery process. This embodiment may allow simple configuration in indicating the TA-specific D2D resources to the UT 500 as the existing TAU accept message is advantageously utilized.

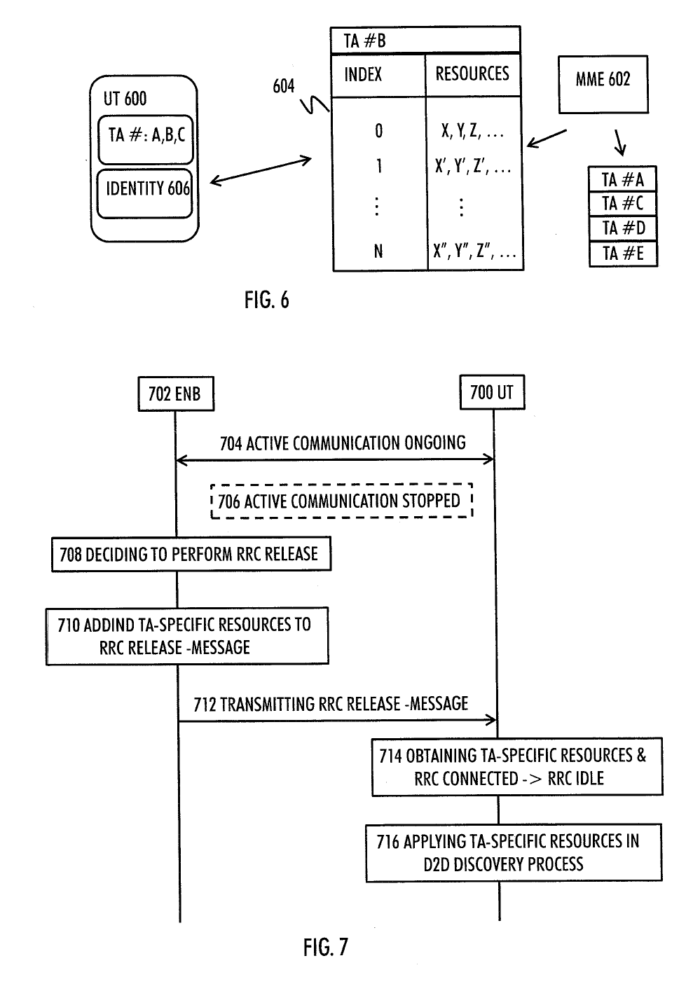

The user terminal may obtain the TA-specific resources also without receiving any signaling from the MME. In an embodiment, as shown in FIG. 6, the UT selects or derives the tracking area-specific resources from a tracking area-specific resource pool 604 provided by the cellular network, wherein the selection is based on at least part of a predetermined identifier of the user terminal 600. In an embodiment, the MME 602 may provide such tracking area-specific resource pool 604. The resource pool 604 may comprise resources available for one specific tracking area. In the case of FIG. 6, the pool is for the TA #B. The resources [X,Y,Z, . . . ], [X′, Y′, Z′, . . . ], . . . , [X″, Y″, Z″, . . . ] may be indexed with appropriate indexes running from 0 to N, for example, as shown in the Figure. The resources may denote, for example, time, frequency, bandwidth, power, etc. As shown in the Figure, the UT 600 may be configured with a plurality of TAs #A, B, C, . . . , whereas the MME 602 may allocate available resources for each TA under its observation. In the case of FIG. 6, the MME serves TAs #A, B, C, D and E. However, only the resource pool for TA #B is detailed. The other resource pools for TAs # A, C, D and E may comprise similar information. The UT 600 may have a certain identity represented by an identifier 606 of the UT 600. In this embodiment, the indexes of the pool 604 are selected so that the identifier 606 may be found from the resource indexes in the pool 604 so that the resources corresponding to the identifier 606 may be selected for the D2D discovery process. It may further be that only part of the identifier 606 is applied in selecting the appropriate index from the pool 604. This may allow for shorter indexing of the resource pool 604.

In a further embodiment, it is proposed that the identifier 606 of the user terminal 600 is the temporary mobile subscriber identity (TMSI or shortened S-TMSI), and a resource index for the tracking area-specific resource pool 604 is obtained by applying an arithmetic operation between the identifier 600 and a total number N of the resource indexes in the tracking area-specific resource pool 604. The network may be able to change the TMSI if this is for some reason desired. One possible use for the TMSI may be the paging of the terminal device 600. The TMSI may thus be a temporary identity for a terminal, which identity is provided from the terminal to the MME 602. In principle any arithmetic operation may suffice in obtaining the correct index of the resource pool 604 for the terminal 600. In one embodiment, the arithmetic operation is a module operation, wherein the resource index for the UT 600 from the whole D2D discovery resource pool 604 per TA is obtained as: TMSI (or part of TMSI) mod N. This embodiment may allow for simple indexing of the pool 604 without complex algorithms.

FIG. 7 shows another embodiment of communicating the TA-specific resources to the user terminal. A base station of the cellular communication network, such as an eNB 702 of FIG. 7, may be actively communicating in step 704 with a UT 700 in the RRC active state. Let us assume that the eNB 602 decides, in step 708, to send an RRC release-message because the active communication between the eNB 702 and the UT 700 may have stopped in step 706. Alternatively, there may be other criteria for deciding to send the RRC release-message, such as an urgent need of radio resources, for example. When the active RRC connection is to be released, the eNB 702 may send an RRC release-message to the UT 700. In the UMTS, the RNC may send such RRC release-message whereas in the LTE, the eNB 702 may send the message to the UT 700. According to the embodiment, the entity transmitting the RRC release, such as the eNB 702 of the LTE, may add the TA-specific resources to the RRC release-message in step 710 before providing the message to the UT 700 in step 712. The RRC release-message may be transmitted on a dedicated control channel (DCCH). The eNB 702 may have obtained the at least one TA-specific D2D resources from another network element, such as from the MME. Thus, the UT 700 may, in step 714, obtain the tracking area-specific resources from a channel carrying indication to release active communication connection to the serving base station 702 of the cellular communication network. This embodiment may provide ease of implementation as the currently existing RRC release message is utilized and extended by adding new fields to carry the at least one TA-specific D2D resources to the UT 700. The UT 700, which may be in or enter to the RRC idle state, may thereafter comprise the D2D resources and may utilize them for the D2D discovery process in step 716 at a point of time determined by the timing related D2D resources, for example.

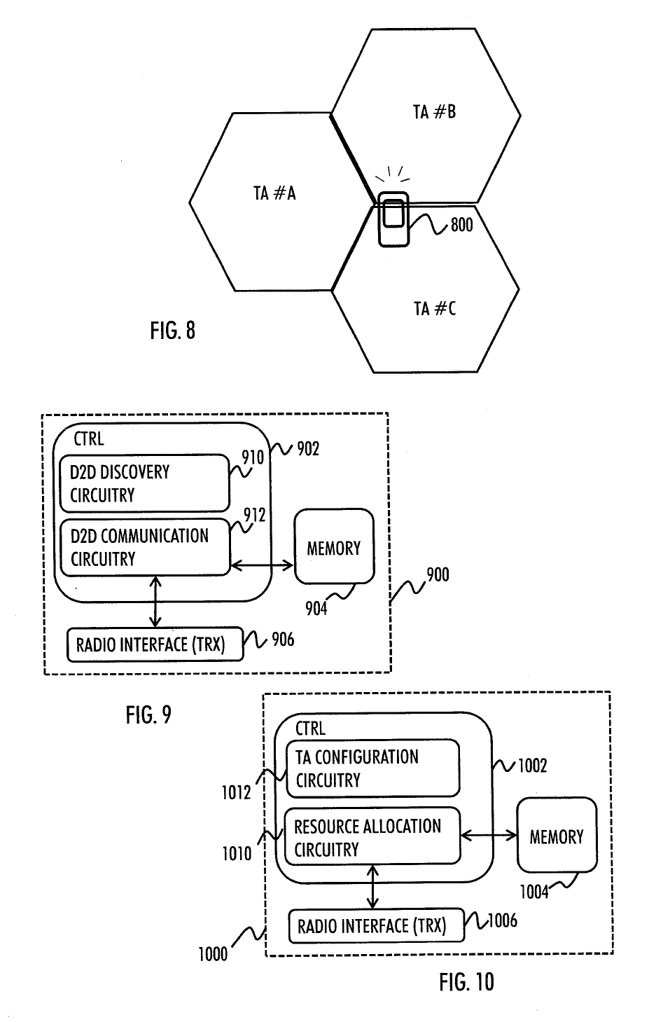

FIG. 8 shows an UT 800 locating in the border area of three tracking areas A, B and C. Let us assume that the UT 800 has obtained information indicating tracking area-specific resource sets for at least two tracking areas, wherein the user terminal 800 is configured with multiple tracking areas. The information may have been obtained according to any of the embodiments presented above. For example, the MME may have provided the at least two TA-specific D2D resource sets to the UT 800.

However, according to an embodiment, in the border area of at least two configured TAs A, B and C, the D2D discovery resources may not be overlapping. In particular, the D2D resources may not be overlapping between neighboring eNBs belonging to different/adjacent TAs. Therefore, in the embodiment, the allocated tracking area-specific resources (or resource sets) of at least the adjacent tracking areas are non-overlapping. Further, the UT 800 may transmit D2D discovery process related signaling on the tracking area-specific resources of only one tracking area. The UT may be informed by the MME or another network entity that the UT is allowed to apply only one of the TA-specific non-overlapping resources. Alternatively, the UT may be precoded with such instructions. The UT 800 may perform the D2D discovery process related signaling only on the resources corresponding to TA #B, for example. This may ensure that the UT 800 is discovered by other UTs located in the TA #B whose D2D resources are used. The UTs in the other TAs #A and C necessarily need not use resources in listening to the UT 800. This may also ease the communication between the MMEs in the scenario where the different TAs A, B and C are configured and monitored by different MMEs because each MME may know that the UTs who discovered each other in the D2D discovery process are within the same TA configured by the one MME. Therefore, this embodiment may not increase the signaling overhead between different MMEs. The TA whose D2D resources are to be applied may be determined by selecting the tracking area which comprises the cell which would be selected by the user terminal 800 in a cell selection algorithm. As explained the UT 800 may perform the cell selection algorithm when it is in an idle state. This may ensure that the UT 800 is applying those resources that are specific for the TA comprising the current cell where the UT 800 camps on. Further, UT 800 may be configured to receive the D2D discovery process related signaling on each of the plurality tracking area-specific resources (or resource sets) when the user terminal is configured with multiple tracking areas. This may ensure, for example, that the UT 800 is able to discover D2D capable UTs in any TA #A, B and C, not only from one TA. The coverage area of the discovery may thus be enlarged.

In another embodiment relating to FIG. 8, the tracking area-specific resources of at least adjacent tracking areas are at least partly over-lapping. For example, the MME may configure at least some overlapping D2D discovery resources among adjacent TAs A, B and C. For that, the TAU accept-message or the RRC release-message, for example, may be extended to include indication of the shared D2D resources among adjacent TAs. In addition, the UT 800 may be preconfigured with or informed of conditions, such as path loss thresholds towards certain eNBs, in order to enable the UT 800 to detect when the UT 800 is in the border area of certain TA. The conditions may be informed separately or simultaneously with the resources, for example. The UT 800 may then, upon detecting that the UT 800 is in the border area of at least one tracking area, transmit and/or receive the D2D discovery process related signaling on the overlapping resources. The UT 800 may be informed by the MME or another network entity that the UT 800 is required to apply the overlapping resources when locating in the border area. Alternatively the UT 800 may be precoded with such instructions. Thus, the UT may be configured such that it is mandatory to transmit and/or receive on these overlapping resources when the device notices being in the border of at least two TAs. This may allow the UT 800 to be detected in any TA which is associated with the overlapping D2D resources.

Embodiments, as shown in FIGS. 9 and 10, provide apparatuses 900 and 1000, each comprising at least one processor and at least one memory including a computer program code, wherein the at least one memory and the computer program code are configured, with the at least one processor, to cause the apparatus 900 and/or 1000 to carry out any one of the above-described processes relating to the D2D discovery process. It should be noted that FIGS. 9 and 10 show only the elements and functional entities required for understanding the apparatuses. Other components have been omitted for reasons of simplicity. The implementation of the elements and functional entities may vary from that shown in the figures. The connections shown in the figures are logical connections, and the actual physical connections may be different. The connections can be direct or indirect and there can merely be a functional relationship between components. It is apparent to a person skilled in the art that the apparatus may also comprise other functions and structures.

Let us first consider the apparatus 900 of FIG. 9. The apparatus 900 may be capable of D2D communication and may comprise the terminal device of a cellular communication system, e.g. a computer (PC), a laptop, a tabloid computer, a cellular phone, a communicator, a smart phone, a palm computer, or any other communication apparatus. In another embodiment, the apparatus 900 is comprised in such a terminal device, e.g. the apparatus may comprise a circuitry, e.g. a chip, a processor, a micro controller, or a combination of such circuitries in the terminal device and cause the terminal device to carry out the above-described functionalities related to the D2D discovery process. Further, the apparatus 900 may be or comprise a module (to be attached to the UT) providing connectivity, such as a plug-in unit, an “USB dongle”, or any other kind of unit. The unit may be installed either inside the UT or attached to the UT with a connector or even wirelessly.

The apparatus 1000 may comprise or be comprised in a network element, such as the mobility management entity (MME), for example. However, the apparatus 1000 may be comprised any cellular communication network element having functionalities relating to configuring TAs and allocating resources. The apparatus 1000 may comprise a circuitry, e.g. a chip, a processor, a micro controller, or a combination of such circuitries and cause the network element to carry out the above-described functionalities regarding the D2D discovery process.

As said, the apparatuses 900 and 1000 may comprise the at least one processor 902 and 1002, respectively. The at least one processor 902, 1002 may be implemented with a separate digital signal processor provided with suitable software embedded on a computer readable medium, or with a separate logic circuit, such as an application specific integrated circuit (ASIC). The at least one processor 902, 1002 may comprise an interface, such as computer port, for providing communication capabilities.

The at least one processor 902 of the apparatus 900 may comprise a D2D discovery circuitry 910. The D2D discovery circuitry 910 may be used for performing the discovery process on the obtained TA-specific resources. The circuitry 910 may, for example, cause transmission or reception of discovery signals on the resources. The at least one processor 902 may also comprise a D2D communication circuitry 912 for performing the actual D2D direct communication with another UT over the cellular radio interface. The at least one processor 1002 of the apparatus 1000 may comprise a resource allocation circuitry 1010 for allocating and causing the apparatus 1000 to provide the TA-specific resources for the user terminal according to any of the embodiments. The allocation of resources may take into account the prevailing traffic situation in the TA as well as the available resources in the TA. The allocation may also comprise consideration of TA configuration, for example, whether the tracking area size of at least one TA need to be adjusted to obtain sufficient amount of resources for the D2D process in that TA. The at least one processor 1002 of the apparatus 1000 may also comprise a tracking area configuration circuitry 1012 for configuring tracking areas for the user terminals and monitoring the mobility within the tracking area(s).

The apparatuses 900 and 1000 may each comprise a memory 904, 1004 connected to the corresponding processor 902, 1002, respectively. However, memory may also be integrated to the processor and, thus, no external memory may be required. The memory 904 may be for storing data related to the obtained at least one TA-specific resources and for storing information related to the discovered D2D devices, for example. The memory 1004 in the apparatus 1000, for example, may be for storing data related to the tracking area configurations, the location information of the UTs, resources that are allocated to the D2D UTs, for example.

The apparatuses 900 and 100 may further comprise radio interface components 906, 1006, respectively, each providing the apparatus with radio communication capabilities with the radio access network. The radio interface components may comprise standard well-known components such as amplifier, filter, frequency-converter, (de)modulator, and encoder/decoder circuitries and one or more antennas.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rear-ranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configure to carry out embodiments of any of the FIGS. 1 to 10. In an embodiment, the at least one processor 902 and 1002, the memory 904 and 1004, respectively, and a computer program code form embodiments of processing means for carrying out the embodiments.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
obtaining, by a user terminal capable to perform direct device-to-device, D2D, communication with another user terminal, information indicating tracking area-specific resources for a D2D discovery process; and
applying the obtained tracking area-specific resources in performing the D2D discovery process within the tracking area, wherein the D2D discovery process is for discovering D2D communication capable devices in the tracking area over an air interface of a cellular network.

2. The method of claim 1, the method further comprising:
causing transmission of information to the cellular network, wherein the information comprises an indication of the capability to perform direct D2D communication; and
causing reception of information indicating the tracking area-specific resources from the cellular network.

3. The method of claim 1, the method further comprising:
selecting the tracking area-specific resources from a tracking area-specific resource pool provided by the cellular network, wherein the selection is based on at least part of a predetermined identifier of the user terminal.

4. The method of claim 1, the method further comprising:
obtaining information indicating tracking area-specific resources of at least two tracking areas, wherein the user terminal is configured with multiple tracking areas and the tracking area-specific resources of at least adjacent tracking areas are non-overlapping;
transmitting D2D discovery process related signaling on the tracking area-specific resources of only one tracking area, wherein the one tracking area-specific resources on which the transmission takes place corresponds to the tracking area comprising the cell which would be selected by the user terminal in a cell selection algorithm; and
receiving the D2D discovery process related signaling on each of the tracking area-specific resources when the user terminal is configured with multiple tracking areas.

5. The method of claim 1, the method further comprising:
obtaining information indicating tracking area-specific resources of at least two tracking areas wherein the user terminal is configured with multiple tracking areas and the tracking area-specific resources of at least adjacent tracking areas are at least partly overlapping; and
upon detecting that the user terminal is in the border area of at least two tracking areas, transmitting and/or receiving the D2D discovery process related signaling on the overlapping resources.

6. A method, comprising:
providing, by a cellular network element to a user terminal capable to perform direct device-to-device, D2D, communication with another user terminal, information indicating tracking area-specific resources for a D2D discovery process in order to enable the user terminal to apply the provided tracking area-specific resources in performing the D2D discovery process within the tracking area, wherein the D2D discovery process is for discovering D2D communication capable devices in the tracking area over an air interface of the cellular network.

7. An apparatus, comprising:
at least one processor and at least one memory including a computer program code, wherein the at least one memory and the computer program code are configured to, with the at least one processor, cause the apparatus at least to:
obtain information indicating tracking area-specific resources for a device-to-device, D2D discovery process of a user terminal capable to perform direct D2D communication with another user terminal; and
apply the obtained tracking area-specific resources in performing the D2D discovery process within the tracking area, wherein the D2D discovery process is for discovering D2D communication capable devices in the tracking area over an air interface of a cellular network.

8. The apparatus of claim 7, wherein the apparatus is further caused to:
cause transmission of information to the cellular network, wherein the information comprises an indication of the capability to perform direct D2D communication; and
cause reception of information indicating the tracking area-specific resources from the cellular network.

9. The apparatus of claim 8, wherein the information indicating the capability to perform direct D2D communication is carried in a tracking area update request and the information indicating the tracking area-specific resources is carried in a tracking area update accept-message.

10. The apparatus of claim 7, wherein the apparatus is further caused to:
select the tracking area-specific resources from a tracking area-specific resource pool provided by the cellular network, wherein the selection is based on at least part of a predetermined identifier of the user terminal.

11. The apparatus of claim 10, wherein the identifier of the user terminal is the temporary mobile subscriber identity, TMSI, and a resource index for the tracking area-specific resource pool is obtained by applying an arithmetic operation between the identifier and a total number of the resource indexes in the tracking area-specific resource pool.

12. The apparatus of claim 7, wherein the apparatus is further caused to:
obtain information indicating tracking area-specific resources of at least two tracking areas, wherein the user terminal is configured with multiple tracking areas and the tracking area-specific resources of at least adjacent tracking areas are non-overlapping;
transmit D2D discovery process related signaling on the tracking area-specific resources of only one tracking area, wherein the one tracking area-specific resources on which the transmission takes place corresponds to the tracking area comprising the cell which would be selected by the user terminal in a cell selection algorithm; and
receive the D2D discovery process related signaling on each of the tracking area-specific resources when the user terminal is configured with multiple tracking areas.

13. The apparatus of claim 7, wherein the apparatus is further caused to:
obtain information indicating tracking area-specific resources of at least two tracking areas wherein the user terminal is configured with multiple tracking areas and the tracking area-specific resources of at least adjacent tracking areas are at least partly overlapping; and
upon detecting that the user terminal is in the border area of at least two tracking areas, transmit and/or receive the D2D discovery process related signaling on the overlapping resources.

14. The apparatus of claim 7, wherein the apparatus is further caused to:
obtain the tracking area-specific resources from a channel carrying indication to release active communication connection to a serving base station of the cellular communication network.

15. An apparatus, comprising:
at least one processor and at least one memory including a computer program code, wherein the at least one memory and the computer program code are configured to, with the at least one processor, cause the apparatus at least to:
provide information to a user terminal indicating tracking area-specific resources for a D2D discovery process in order to enable the user terminal to apply the provided tracking area-specific resources in performing the D2D discovery process within the tracking area, wherein the D2D discovery process is for discovering D2D communication capable devices in the tracking area over an air interface of the cellular network.

16. The apparatus of claim 15, further comprising:
causing reception of information from the user terminal, wherein the information comprises an indication of the capability to perform direct D2D communication; and
causing transmission of information indicating the tracking area-specific resources to the user terminal.

17. The apparatus of claim 15, wherein the apparatus is further caused to:
provide a tracking area-specific resource pool in order to allow the user terminal to select the tracking area-specific resources from the provided tracking area-specific resource pool, wherein the selection is based on at least part of a predetermined identifier of the user terminal.

18. The apparatus of claim 15, wherein the apparatus is further caused to:
provide information indicating tracking area-specific resources of at least two tracking areas, wherein the user terminal is configured with multiple tracking areas and the tracking area-specific resources of at least adjacent tracking areas are non-overlapping; and
cause the user terminal to transmit D2D discovery process related signaling on the tracking area-specific resources of only one tracking area, and to receive the D2D discovery process related signaling on each of the tracking area-specific resources when the user terminal is configured with multiple tracking areas,
wherein the one tracking area-specific resources on which the transmission takes place corresponds to the tracking area comprising the cell which would be selected by the user terminal in a cell selection algorithm.

19. The apparatus of claim 15, wherein the apparatus is further caused to:
provide information indicating tracking area-specific resources of at least two tracking areas, wherein the user terminal is configured with multiple tracking areas and the tracking area-specific resources of at least adjacent tracking areas are at least partly overlapping; and
cause the user terminal to transmit and/or receive the D2D discovery process related signaling on the overlapping resources when the user terminal is in the border area of at least two tracking areas.

20. A computer program product embodied on a distribution medium readable by a computer and comprising program instructions which, when loaded into an apparatus, execute the method according to claim 1.
